(19) United States
(12) Patent Application Publication
(10) Pub. No.: US 2012/0281912 A1
(43) Pub. Date: Nov. 8, 2012

(54) SYSTEM FOR MANAGING DETECTION OF ADVERTISEMENTS IN AN ELECTRONIC DEVICE, FOR EXAMPLE IN A DIGITAL TV DECODER,

(75) Inventor: Jean-Pierre Morard, Rueil-Malmaison (FR)

(73) Assignee: SAGEMCOM BROADBAND SAS, Rueil-Malmaison (FR)

(21) Appl. No.: 13/513,246

(22) PCT Filed: Sep. 8, 2010
(86) PCT No.: PCT/EP2010/063197

§ 371 Date: Jul. 26, 2012

(30) Foreign Application Priority Data
Dec. 2, 2009 (FR) 0958596

(51) Int. Cl. G06K 9/62

(52) U.S. Cl. 382/165; 382/224

(57) ABSTRACT

A method for generating the result of a search carried out using a search engine, in which a list of results is established after the search operation, the method including: identifying the thumbnail images associated with illustrated results from the list of results; carrying out an analysis operation of the images that includes comparing, by pairs, the identified thumbnail images; grouping, into image families, the thumbnail images sharing a similarity predetermined by the operation of comparing the thumbnail images; and generating the result of the search on the basis of the groupings into image families.

### TECHNICAL FIELD OF THE INVENTION

The object of the present invention is a method for generating the result of a search carried out using a search engine. Essentially, the object of the present invention is to improve the readability of the results of a computer search launched by means of a search engine, particularly on the Internet network.

The field of the invention is, in general, that of the search for information on a communication network. The invention may be implemented on any communication network using search engines sending, in particular, visual data; Here, the visual data under consideration is of the thumbnail type. The invention will be described in the case where the communication network under consideration is the Internet network, the network which a user accesses by means of an Internet browser; The network on which the user may carry out a search by means of a search engine. Nevertheless, the invention may be implemented on other types of networks, for example company Intranet networks.

### TECHNOLOGICAL BACKGROUND OF THE INVENTION

Today, more and more documents are digitized and are accessible by means of search engines. An immediate consequence of the increase in the number of documents that are digitized and accessible on line is the increase in the number of results obtained when a search is carried out by means of an Internet browser, for example by means of keywords. If the results obtained consequently present a relatively thorough character, it is increasingly difficult for a user to find, from among a list of search results, the desired information. Certain search engines manage to prioritize the relevance of the results found, but a manual step still remains that the user must perform to select, from among the list of results obtained, the results that really interest the user.

To facilitate this manual step, some browsers, that most often return a list of results in the form of a line of text associated with a URL, supplement the search results with a thumbnail type image. Thumbnail refers to a reduced-size image allowing the result to which it is associated to be visually identified. For example, a thumbnail may be constituted of the image of the sleeve of a disk or the cover of a book. The size of the thumbnail is voluntarily reduced so as to be able to be positioned, for example, in line with a text associated with the search result, and to be able to maintain the ability to simultaneously display, visibly on a screen, a significant number of search results. In certain cases, the thumbnail constitutes in itself a result line of the search carried out, by not being associated with a line of text. Therefore a thumbnail may, after a search, appear either directly or by being associated with URL address type information.

However, a difficulty remains: Despite the use of thumbnails, the results of a search carried out by a search engine may be presented in a relatively disorganized manner, and may be difficult for a user to utilize. Nevertheless, in most cases, these results comprise families of results, each result family corresponding to results designating comparable elements. But these result families are not, in practice, grouped together.

Therefore, for example, if a user searches for a particular album, the title of which he has forgotten, of a given artist, he will enter in the appropriate window of his search engine the name of the artist. The different albums will then appear in the list of results; but the different results for a given album of the artist under consideration are not necessarily grouped together, for example in successive lines of the search result; In fact, a same album may be referenced with different URLs that are not necessarily successive in the list of results. In addition, small variations in the same album may exist, in the sleeve; this is the case, for example, between “simple” editions of an album and “collector” editions; The fact remains that the different editions of the same album correspond to the same work of an artist, and that it therefore may appear of interest to group them together in a list of results produced by a search engine, in order to facilitate the searches of a user. The example that has just been described with albums of an artist is easily transferrable, in the context of the invention, to other items, such as books, DVDs or other items.

### GENERAL DESCRIPTION OF THE INVENTION

The method according to the invention proposes a solution to the problem that has just been stated. The invention proposes a solution so that the thumbnails generated when a search is launched by means of a search engine are grouped together by family of items in the list of results produced by the search engine. Family of items refers to a plurality of items whose associated thumbnails present a resemblance such that they are considered to refer to the same object. For that purpose, carrying out an operation to compare the different thumbnails issued from the search, and to group together similar thumbnails, that present strong resemblances, is proposed in order to make the search result more readable to the user.

The invention essentially relates to a method for generating the result of a search carried out using a search engine, in which a list of results is established after said search operation, characterized in that said method comprises the different steps consisting of:
identifying thumbnail type images associated with illustrated results from the list of results;
carrying out an analysis operation of the images that consists of comparing, by pairs, the identified thumbnail type images;
grouping into image families the thumbnail type images sharing a similarity determined by the operation of comparing the thumbnail type images;
generating the result of the search according to the groupings into image families.

In practice, two images are considered to present a similarity between each other if they effectively represent a same object, the images may present between them differences in the order of detail. Typically, two images may be considered to be similar to each other if, returned in the same format and in identical dimensions, fewer than 20% of pixels constituting the two images present different component values.

The method according to the invention may comprise, in addition to the main steps that have just been mentioned in the previous paragraph, one or more additional characteristics from among the following:
the comparison operation is carried out by means of an encoder;
the encoder is of the H264 type;
the comparison operation carried out by means of the encoder comprises different steps consisting of:
   constituting all possible pairs of thumbnail type images from the identified thumbnail type images;
   for each pair of constituted images, carrying out an operation of encoding said pair of images by means of the encoder;
   determining from the encoding operation variations between the two images from the pair of images;
   quantifying the variations between the two images from the pair of images under consideration to obtain a quantification value;
   if the quantification value of the pair of images under consideration is less than a previously determined variation threshold, grouping the two images from the image pair in a same image family;
prior to the image analysis step, said method comprises the step consisting of accessing a high-resolution image associated with each identified thumbnail, the image analysis step then being carried out on the high-resolution images;
prior to the image analysis step, said method comprises the step consisting of converting the identified thumbnail type images into a same image format;
the image format in which the identified thumbnail type images are converted is the YUV format;
the step consisting of identifying the thumbnail type images associated with illustrated results from the list of results is carried out on a previously determined number of results from said list of results.

The different additional characteristics of the method according to the invention, insofar as they are not mutually exclusive, are combined according to all combination possibilities to result in different examples of embodiment of the invention.

The invention and its various applications will be better understood upon reading the following description and examining the accompanying figures.

### BRIEF DESCRIPTION OF THE FIGURES

The figures are presented for indicative purposes and in no way limit the invention. The figures show:

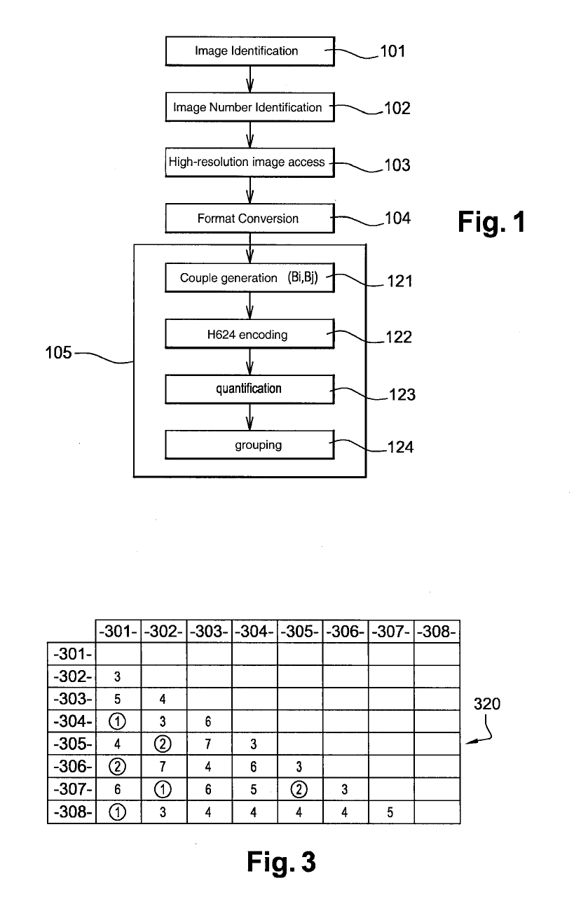

in FIG. 1, a diagram illustrating an example of implementation of the method according to the invention;

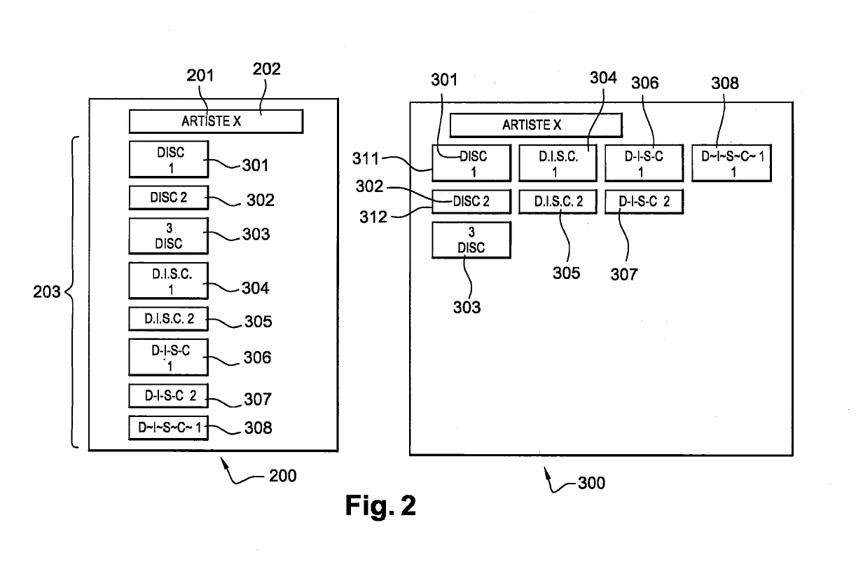

in FIG. 2, a schematic representation of a generation of results of a search carried out by means of a search engine according to the invention;

in FIG. 3, a representation of a table of values illustrating the grouping of images by image families.

### DESCRIPTION OF PREFERRED FORMS OF EMBODIMENT OF THE INVENTION

Unless stated otherwise, elements appearing in different figures will keep the same references.

FIG. 1 represents a diagram illustrating an example of implementation of the method according to the invention; Different steps of said program organizing the method of generating a result from a search being illustrated in FIG. 2.

FIGS. 1 and 2 will therefore be described at the same time.

The present invention is described in the context of a search carried out by a user by means of a search engine on the Internet network.

FIG. 2 represents a first screen 200 and a second screen 300 representing the results of a search respectively before the implementation of the method according to the invention and after the implementation of the method according to the invention. In the example represented, the user launches a search by typing a set of keywords 201, here “artist X,” in a field 202 of a search engine. The user then obtains a list of results 203, corresponding to disk sleeves, that are hierarchically organized according to methods specific to each search engine. In the example illustrated, the list of results 203 is limited, in the interest of simplification, to thumbnails, the texts associated with URL addresses that are possibly present in practice having been omitted. Therefore, here it is considered that the list of results is exclusively composed of illustrated results, i.e., results associated with a thumbnail. Still in the interest of simplification, the list of results 203 is limited to a list of eight results, referenced 301 to 308 in their order of presentation on the screen. In practice, the number of results is very often much higher, and the use of thumbnails must be a tool for discrimination in the selection of results of interest to the user.

In the example represented, three albums are listed for artist X; a first album bears the description “Disc 1” (thumbnails 301; 304 ; 306 and 308), a second album bears the description “Disc 2” (thumbnails 302; 305 and 307), and a third album bears the description “Disc 3” (thumbnail 303). As may be observed, the different albums appear in the list of results in a disorganized manner: The different cases of an album under consideration not being grouped together in the list of results, which is impractical for a user, notably when the list of results 203 comprises a large number of results.

As illustrated in FIG. 1, to generate a search result according to an example of embodiment of the method according to the invention, in a first step 101, the invention carries out an operation to identify the thumbnail type images in the list of results 203. Such an operation may be carried out by conventional image processing operations, or by identifying the URLs associated with the thumbnails. In a particular embodiment of the invention, in a following step 102, the identification of thumbnails is limited to a previously determined number, for example fifty, in order to limit the quantity of calculations subsequently intervening, and by considering that such a limitation will facilitate the task of the user in selecting the results that effectively interest the user. In the example under consideration, it is limited to the eight thumbnails previously mentioned.

Advantageously, in a following step 103, an operation is carried out to access high-resolution images associated with the thumbnails under consideration. For that purpose, the URL associated with the thumbnail under consideration, for example, may be used.

In a following step 104, an operation is carried out to convert the thumbnail type images (if necessary, in their high-resolution version) from their original format (jpeg, gif, etc.) To a format that is directly usable by an encoder type device. Such a format is for example the YUV 4:2:0 format, or the ROB format.

In a following step 105, a step is carried out of analyzing images on the basis of the converted images. In the example under consideration, this step comprises the following different operations:
an operation 121 of constituting image pairs, by combining according to all possibilities all identified images; Therefore, in the example under consideration, from eight identified thumbnails, 28 pairs of two images (Bi, Bj) are obtained, with i and j belonging to the set {1-8}.
an operation 122 during which the pairs (Bi, Bj) are encoded by an H264 type decoder; In other examples of embodiment, the encoder may be of the VC1 or Dirac type. Therefore at the output of the encoder, for each encoded pair (Bi, Bj), a set of information is obtained in the form of a succession of data as follows: {Ri, P(i,1), P(i,2), . . . , P(i,m)}, where Ri is the compressed format of the image Bi, and the data P(i,m) are data indicative of the change observed between image Bj and image Bi, the value m corresponding to the number of zones (generally rectangular) of the image where variations between image Bi and image Bj have been observed.
an operation 123 in the course of which the differences observed between image Bi and image Bj are quantified for each pair of images (Bi, Bj) having undergone the encoding operation; For that purpose, the set of information {Ri, P(i,1), P(i,2), . . . , P(i,m)} is considered, and for each encoded pair (Bi, Bj), all of the data P(i,m) is added to obtain a value known as the differentiation value. The lower this value, the higher the resemblance between images Bi and Bj.
an operation 124 to group images, together, during which images Bi and Bj that, after the operations that have just been described, present a differentiation value that is lower, or lower or equal, than or to a previously determined threshold, are grouped together in a same image family. The images grouped into a same image family are then considered to share a similarity.

FIG. 3 schematically illustrates the constitution of image families. A table 320 is represented in this figure, each line of the table and each column of the table corresponding to one of eight thumbnails 301 to 308. The intersection of a line associated with a thumbnail and a column associated with another thumbnail gives a value called the comparison value calculated according to the method that has just been described. Therefore, the image grouping operation is carried out by grouping the images for which the comparison value is less than a previously determined threshold value.

In the example under consideration, the value of 2 is taken as the threshold value. Therefore, as seen in FIG. 2 at screen 300, where the result of the search generated following the implementation of the method according to the invention is represented schematically:
thumbnails 301, 304, 306 and 308 are grouped together on a same line to form a first image family 311; in fact, the only differences between these thumbnails consists of the presence of symbols between the different letters of the word “Disc,” these thumbnails being identical in all other ways;
thumbnails 302, 305 and 307 are grouped together on a same line to form a second image family 312; in fact, the only differences between these thumbnails consists of the presence of symbols between the different letters of the word “Disc,” these thumbnails being identical in all other ways.

The user may therefore more easily locate the searched objects.

1. A method for generating the result of a search carried out using a search engine, in which a list of results is established after said search the method comprising:
identifying thumbnail type images associated with illustrated results from the list of results;
carrying out an analysis operation of the images that includes comparing, by pairs, the identified thumbnail type images;
grouping into image families the thumbnail type images sharing a similarity determined by comparing the thumbnail type images; and
generating the result of the search according to the groupings into image families.

2. The method according to claim 1, wherein the comparing is carried out with an encoder.

3. The method according to claim 2, wherein the encoder is of the H264 type.

4. The method according to claim 2, wherein the comparing carried out with the encoder comprises:
constituting all possible pairs of thumbnail type images (Bi, Bj) from the identified thumbnail type images;
for each pair of constituted images, encoding said pair of images with the encoder;
determining, from the encoding, variations between the two images from the pair of images;
quantifying the variations between the two images from the pair of images under consideration to obtain a quantification value;
if the quantification value of the pair of images under consideration is less than a previously determined variation threshold, grouping the two images from the image pair in a same image family.

5. The method according to claim 1, wherein, prior to carrying out the image analysis operation, said method comprises accessing a high-resolution image associated with each identified thumbnail, the image analysis then being carried out on the high-resolution images.

6. The method according to claim 1, wherein, prior to carrying out the image analysis operation, said method comprises converting the identified thumbnail type images into a same image format.

7. The method according to claim 6, wherein the image format in which the identified thumbnail type images are converted is the YUV format.

8. The method according to claim 1, wherein identifying the thumbnail type images associated with the illustrated results from the list of results is carried out on a previously determined number of results from said list of results.
